(19) United States
(12) Patent Application Publication
(10) Pub. No.: US 2026/0147534 A1
(43) Pub. Date: May 28, 2026

(54) ACOUSTIC CHARACTERISATION OF AUDIO APPARATUS WITH RADIO-WAVE LOCATING

(71) Applicant: SAGEMCOM BROADBAND SAS, Bois-Colombes (FR)

(72) Inventors: Pierre SABATIER, Bois-Colombes (FR); Gilles BOURGOIN, Bois-Colombes (FR)

(21) Appl. No.: 19/400,832

(22) Filed: Nov. 25, 2025

(30) Foreign Application Priority Data
Nov. 25, 2024 (FR) FR2412954

(51) Int. Cl. G06F 3/16; H04H 20/86

(52) U.S. Cl. CPC G06F 3/165; H04H 20/86

(57) ABSTRACT

An audio broadcasting apparatus is arranged to implement multichannel audio playback on the basis of first audio signals in an audio system and to: acquire a position of the audio playback apparatus, said position being obtained by a locating method using radiofrequency waves; acquire at least one audio parameter representative of an acoustic response of the audio playback apparatus; adapt at least one of the first audio signals depending on the position of the audio playback apparatus and the at least one audio parameter, to obtain second audio signals; implement the multichannel audio playback using the second audio signals.

The invention relates to the field of audio systems comprising an audio broadcasting apparatus (e.g. a set-top box) and one or more audio playback apparatuses (e.g. a television).

### BACKGROUND

A set-top box (STB) is an audio-video broadcasting apparatus whose primary function is to acquire and decode an audio-video stream and to have the video signal broadcast by a television and the audio stream broadcast by the loudspeakers of the television and/or optionally by other audio playback apparatuses (soundbar, smart speakers, etc.).

Some of the latest set-top boxes include one or more loudspeakers. The one or more loudspeakers can be used as part of a voice assistant function and for contributing to the implementation of a multichannel audio system that plays back the audio stream of the audio-video stream. Multichannel playback allows the sound to be rendered optimally and immersively.

The multichannel audio system thus comprises audio channels comprising the loudspeakers of the set-top box, as well as optionally the loudspeakers of the television, and/or the loudspeakers of other audio playback apparatuses connected to the set-top box (soundbar, smart speakers, etc.).

A new audio playback apparatus, for example a new television, is to be integrated in an audio system comprising a set-top box. To implement the multichannel playback, the sound playback of the various audio playback apparatuses in the system has to be synchronised and homogenised.

There are known methods which are implemented by an audio-video amplifier connected to speakers and which allow the sound playback to be optimised and homogenised among the different audio playback apparatuses. However, in these prior-art methods, the speakers have to be known to the amplifier, which is a significant constraint for the user.

### OBJECT

An object of the invention is to integrate an “unknown” audio playback apparatus in an audio system comprising an audio broadcasting apparatus that implements multichannel playback.

### SUMMARY

To achieve this object, an audio broadcasting apparatus is proposed, which is arranged to implement multichannel audio playback on the basis of first audio signals in an audio system comprising a plurality of audio devices, at least one of the audio devices being integrated in an audio playback apparatus separate from the audio broadcasting apparatus, the audio broadcasting apparatus comprising a processing unit arranged to:
acquire a position of the audio playback apparatus, said position being obtained by a locating method using radiofrequency waves;
acquire at least one audio parameter representative of an acoustic response of the audio playback apparatus;
adapt at least one of the first audio signals depending on the position of the audio playback apparatus and the at least one audio parameter, to obtain second audio signals;
implement the multichannel audio playback using the second audio signals.

The processing unit of the audio broadcasting apparatus (e.g. a set-top box) thus acquires the position of the audio playback apparatus (e.g. a television) and the audio parameter(s) representative of the acoustic response of the audio playback apparatus. The processing unit uses this information to precisely configure the audio system so as to synchronise and homogenise the sound among the different apparatuses of the audio system.

Thus, an “unknown” audio playback apparatus, i.e. whose position and acoustic performance are not known, can be acoustically integrated optimally in a controlled audio system to ensure optimal audio rendering.

Also proposed is an audio broadcasting apparatus as described above in which the processing unit is also arranged to acquire an orientation of the audio playback apparatus and to also adapt at least one of the first audio signals depending on the orientation of the audio playback apparatus.

Also proposed is an audio broadcasting apparatus as described above comprising a first primary locator module arranged to carry out a time-of-flight measurement method to measure a distance between the audio broadcasting apparatus and the audio playback apparatus, and an angle measurement method to measure at least one angle between the audio broadcasting apparatus and the audio playback apparatus.

Also proposed is an audio broadcasting apparatus as described above in which the first primary locator module comprises a primary UWB module arranged to communicate with a secondary UWB module of the audio playback apparatus.

Also proposed is an audio broadcasting apparatus as described above in which the primary UWB module comprises two first pairs of antennas positioned orthogonally to each other, the two first pairs of antennas being arranged to interact with at least one second pair of antennas integrated in the secondary UWB module.

Also proposed is an audio broadcasting apparatus as described above in which the first primary locator module is arranged to implement a radar technique, preferably Doppler, and comprises a radar source arranged to interact with at least one radiofrequency tag positioned on the audio playback apparatus.

Also proposed is an audio broadcasting apparatus as described above in which the at least one audio parameter is selected from:
an acoustic delay due to a transmission chain between the audio broadcasting apparatus and the audio playback apparatus and/or due to processing performed by the audio playback apparatus, and
a transfer function of the audio playback apparatus.

Also proposed is an audio broadcasting apparatus as described above in which the at least one audio parameter comprises an indicator of a sound level change resulting from a volume control issued by a user to the audio playback apparatus, the processing unit being arranged to adapt, depending on said indicator, at least one first audio signal transmitted to the audio playback apparatus so as to compensate for said sound level change.

Also proposed is an audio broadcasting apparatus as described above in which the audio broadcasting apparatus is a set-top box that includes an audio device comprising at least one loudspeaker.

Also proposed is an audio broadcasting apparatus described above in which the audio broadcasting apparatus is arranged to determine a position of a user, the processing unit being arranged to also adapt at least one first audio signal depending on the position of the user.

Also proposed is an audio broadcasting apparatus as described above in which the audio broadcasting apparatus is connected to an ancillary apparatus separate from both the audio broadcasting apparatus and the audio playback apparatus and is arranged to receive from said ancillary apparatus the position of the audio playback apparatus and said at least one audio parameter.

In addition, an audio broadcasting method is proposed, which is carried out in the processing unit of an audio broadcasting apparatus as described above, comprising the steps of:
acquiring a position of the audio playback apparatus, said position being obtained by a locating method using radiofrequency waves;
acquiring at least one audio parameter representative of an acoustic response of the audio playback apparatus;
adapting at least one of the first audio signals depending on the position of the audio playback apparatus and the at least one audio parameter, to obtain second audio signals; using the second audio signals to implement the multichannel audio playback.

In addition, a computer program is proposed, comprising instructions that cause the processing unit of the audio broadcasting apparatus as described above to execute the steps of the audio broadcasting method as described above.

In addition, a computer-readable storage medium is proposed, on which the computer program as described above is stored.

In addition, an ancillary apparatus is proposed, which is arranged to be connected to an audio broadcasting apparatus as described above, the ancillary apparatus comprising: a second primary locator module arranged to evaluate the position of the audio playback apparatus, the second primary locator module being arranged to carry out the locating method using radiofrequency waves;
an audio capture module comprising at least one microphone and arranged to produce the at least one audio parameter representative of the acoustic response of the audio playback apparatus;
a first communication module arranged to transmit to the audio broadcasting apparatus the position of the audio playback apparatus and the at least one audio parameter.

Also proposed is an ancillary apparatus as described above in which first communication module is arranged to receive the second audio signals transmitted by the audio broadcasting apparatus, the ancillary apparatus further comprising a second communication module arranged to transmit the second audio signals to the audio devices of the audio system to implement the multichannel audio playback.

In addition, a system is proposed, comprising the audio broadcasting apparatus as described above and a secondary locator module, which is arranged to be positioned on the audio playback apparatus and used to carry out the locating method.

Also proposed is a system as described above comprising an audio broadcasting apparatus as described above, the radiofrequency locator module comprising said at least one radiofrequency tag, which is a passive tag comprising an array of dielectric resonators and a Van Atta reflector.

Also proposed is a system as described above comprising an audio broadcasting apparatus as described above, the radiofrequency locator module comprising the at least one radiofrequency tag, which is an active tag comprising a Van Atta reflector, a microwave switch and a processor arranged to activate and deactivate the Van Atta reflector, according to a determined frequency, by controlling the one or more microwave switches.

Also proposed is a system as described above comprising an audio broadcasting apparatus as described above, the system further comprising the ancillary apparatus as described above.

The invention will be better understood in the light of the following description of particular, non-limiting embodiments of the invention.

### BRIEF DESCRIPTION OF THE DRAWINGS

Reference will be made to the accompanying drawings, in which:

FIG. 1 shows a set-top box and a television;

FIG. 2 shows steps of an audio broadcasting method carried out in the set-top box;

FIG. 3 illustrates the TWR technique;

FIG. 4 illustrates the PDoA technique;

FIG. 5 shows the primary UWB module;

FIG. 6 shows the different angles of the set-top box and the television;

FIG. 7 shows a set-top box and a television;

FIG. 8 shows the television in its reference position and the television oriented at an angle β;

FIG. 9 shows a Van Atta reflector;

FIG. 10 illustrates the principle of determining the orientation angle β formed by the normal to the surface of the tag with respect to the normal to the reference surface of the set-top box;

FIG. 11 shows an active tag;

FIG. 12 shows a set-top box and a television;

FIG. 13 is a graph showing the curves of the emitted synchronisation signal and the received synchronisation signal;

FIG. 14 is a graph showing the intercorrelation between the emitted synchronisation signal and the received synchronisation signal;

FIG. 15 shows a graph including the curve of the emitted test signal, a graph including the curve of the received test signal, and a graph showing the transfer function of the television;

FIG. 16 shows a set-top box, a television and a user;

FIG. 17 shows a set-top box, a television, speakers and an ancillary apparatus.

### DETAILED DESCRIPTION

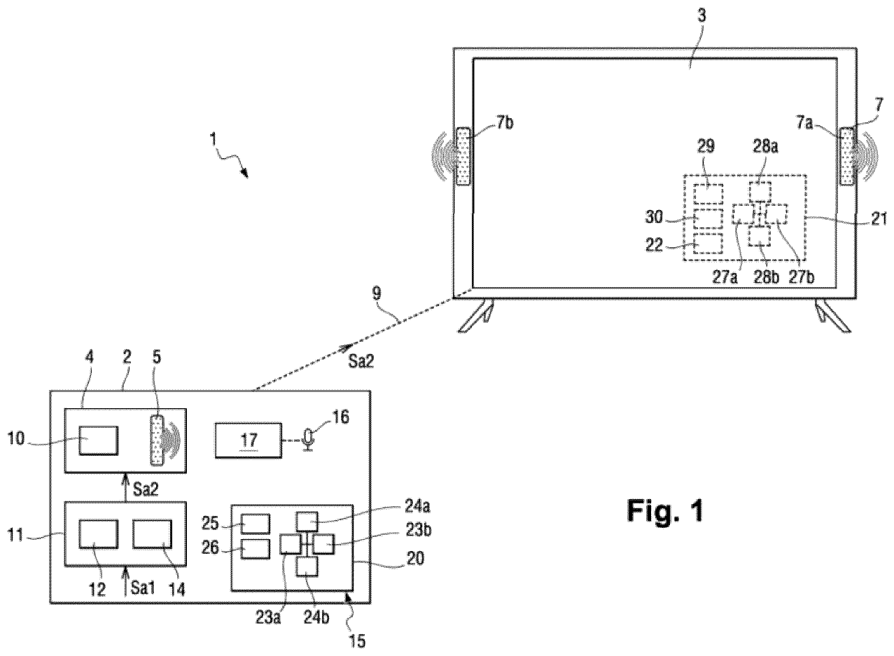

With reference to FIG. 1, the audio system 1 comprises an audio broadcasting apparatus 2 and an audio playback apparatus 3, which are two separate apparatuses connected to each other.

The term “audio broadcasting apparatus” means an apparatus which acquires (externally or internally) an audio stream comprising one or more audio signals and which transmits the audio signal(s) to one or more audio playback apparatuses in order for said signals to be played back.

The term “audio playback apparatus” means an apparatus which comprises an audio device comprising at least one loudspeaker, which receives at least one audio signal and plays it back by producing a sound signal by means of its loudspeaker(s).

Here, the audio broadcasting apparatus 2 is a set-top box (also called a TV decoder or audiovisual decoder). The set-top box 2 is an “advanced” set-top box that includes an audio device 4 comprising a plurality of loudspeakers 5.

Here, the audio playback apparatus 3 is a television which also includes an audio device comprising a plurality of loudspeakers 7, in this case a right-hand loudspeaker 7a and a left-hand loudspeaker 7b.

The audio system 1 may also include other audio playback apparatuses, such as “satellite” speakers placed around the television 3, but these are not mentioned for now.

Here, the set-top box 2 and the television 3 are connected by an HDMI link 9 (High-Definition Multimedia Interface).

The primary functions of the set-top box 2 are to receive and process an audio-video stream, to separate the audio stream and the video stream, and to transmit the video stream to the television 3 and transmit all or part of the audio stream to the audio devices of the audio system 1.

The audio-video stream may come from any source, for example, a broadcast network (satellite television network, internet connection, digital terrestrial television network (DTT), cable television network, etc.), another apparatus connected to the set-top box (a CD, DVD or Blu-ray player, a smartphone, a tablet, etc.) or a storage medium (for example a USB stick or a memory card connected to the set-top box).

The set-top box 2 also plays the role of audio playback apparatus in the audio system 1; its loudspeakers 5 play back part of the audio stream.

The audio device 4 of the set-top box 2 also comprises an audio chain 10 comprising components (in particular one or more audio amplifiers) which format the audio signals played back by the loudspeakers 5 of the set-top box 2.

The set-top box 2 additionally comprises a processing unit 11. The processing unit 11 is an electronic and software unit. The processing unit 11 comprises at least one processing component 12, which is, for example, a “general-purpose” processor, a processor specialising in signal processing (digital signal processor, DSP), a processor specialising in artificial intelligence algorithms (neural processing unit, NPU), a microcontroller, or a programmable logic circuit, such as an FPGA (field-programmable gate array) or an ASIC (application-specific integrated circuit).

The processing unit 11 also comprises one or more memories 14, connected to or integrated in the one or more processing components 12. At least one of these memories 14 forms a computer-readable storage medium on which at least one computer program is stored, said computer program comprising instructions that cause the processing unit 11 to execute the steps of the audio broadcasting method described below.

The audio stream comprises first audio signals Sa1.

The processing unit 11 of the set-top box 2 implements multichannel audio playback in the audio system 1 on the basis of the first audio signals Sa1 of the audio stream.

The set-top box 2 additionally comprises a first primary locator module 15. The first primary locator module 15 implements a locating method using radiofrequency waves to determine the position of the television 3 and therefore of the loudspeakers 7 of the television 3. Advantageously, the locating method also makes it possible to determine the orientation of the television 3 and therefore of the loudspeakers 7 of the television 3.

In the context of the present invention, the term “radiofrequency” should be understood broadly as potentially including:
a radio wave whose spectrum belongs to the frequency range from 8.3 kHz to 3000 GHz, in particular from 3.1 to 10.6 GHz; or
an optical wave in particular in the infrared range.

The set-top box 2 further comprises one or more microphones 16 and an acquisition chain 17 connected to the microphones 16 for processing the audio signals produced by the microphones 16 from the capture of sound signals. The set-top box 2 uses in particular these microphones 16 to acquire at least one audio parameter representative of an acoustic response of the television 3.

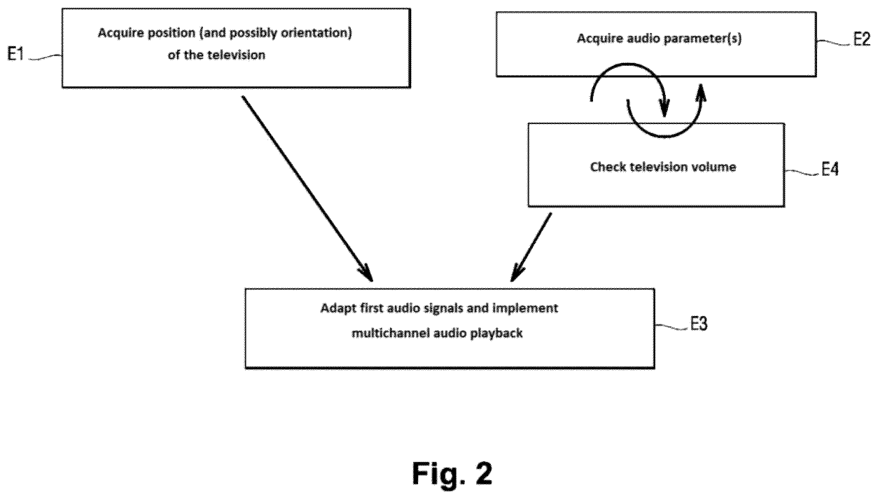

With reference to FIG. 2, the processing unit 11 of the set-top box 2 is arranged to:
acquire a position of the television 3, said position being obtained by a locating method using radiofrequency waves: step E1;
acquire at least one audio parameter representative of an acoustic response of the television 3: step E2;
adapt at least one of the first audio signals Sa1 depending on the position of the television 3 and the at least one audio parameter, to obtain second audio signals Sa2, and implement the multichannel audio playback using the second audio signals Sa2: step E3.

Advantageously, in step E1 the processing unit 11 also acquires the orientation of the television 3, and in step E3 the processing unit 11 also adapts at least one of the first audio signals Sa1 depending on the orientation of the television 3.

Adapting each first audio signal Sa1 comprises, for example, optimising the level of said first audio signal Sa1 according to the frequency.

The processing unit 11 therefore acquires the audio stream, produces the second audio signals Sa2 from the first audio signals Sa1 and implements the multichannel audio playback using the second audio signals Sa2, which are transmitted to the audio devices of the audio system 1 (which in this case are integrated in the television 3 and the set-top box 2).

It is understood that any second audio signal Sa2 associated with a first audio signal Sa1 that does not undergo the aforementioned adaptation is the same as the first audio signal Sa1 itself.

As will be discussed below, the audio parameters may include an indicator of a television volume change. The processing unit 11 checks the volume and adapts one or more first audio signals Sa1 to compensate for this change: step E4.

Thus, without knowing the television 3, the set-top box 2 can acoustically characterise it within the user's environment and thus take account of its acoustic performance, which includes, for example, the frequency response and the efficiency, in consideration also of reverberations and reflections of the sound depending on the position of the television 3 relative to the walls of the room and objects. This provides immersive sound playback including the loudspeakers 7 of the television 3.

The processing illustrated in FIG. 2 is carried out, for example, each time the audio system 1 is calibrated or at regular intervals (for example every day).

First, the locating method for determining the position and, optionally, the orientation of the television 3 will be addressed.

The first primary locator module 15 is arranged to carry out a time-of-flight measurement method to measure a distance between the set-top box 2 and the television 3, and an angle measurement method to measure at least one angle between the set-top box 2 and the television 3.

The locating method preferably uses UWB (Ultra-Wideband) technology.

In a first embodiment, the locating method uses a TWR technique (Two-Way Ranging) and a PDoA technique (Phase Difference of Arrival). Jointly implementing these two techniques allows a 3D location to be obtained (which corresponds to the case of an audio system installed in a house).

As shown in FIG. 1, the first primary locator module 15 of the set-top box 2 comprises a primary UWB module 20.

A secondary (radiofrequency) locator module, which here is a secondary UWB module 21, is installed on the television 3. It is, for example, a tag (e.g. a sticker) which can be affixed permanently or only temporarily. The secondary UWB module 21 is provided with a battery or cell 22 for its power supply.

It goes without saying that the position of the secondary UWB module 21 in the figures does not correspond to the actual position. The module 21 is preferably positioned in the middle of the top portion of the frame of the television 3 in order to locate the loudspeakers of the television 3.

The primary UWB module 20 communicates with the secondary UWB module 21. The locating method therefore uses the TWR technique to calculate a UWB signal time of flight in order to measure a distance between the primary UWB module 20 and the secondary UWB module 21, and uses the PDoA technique to measure at least one angle between the set-top box 2 and the television 3.

The UWB principle is based on wave trains containing both information and a timestamp, the system also being time-synchronised. The wave train is sent by an emitter and received by a receiver, which decodes it and then sends it back to the emitter. The radio time of flight is thus determined by measuring the travel time in both directions and subtracting the path delays in the electronics as well as the software processing times in both the emitter and the receiver. The time of flight (ToF) is determined by the TWR technique.

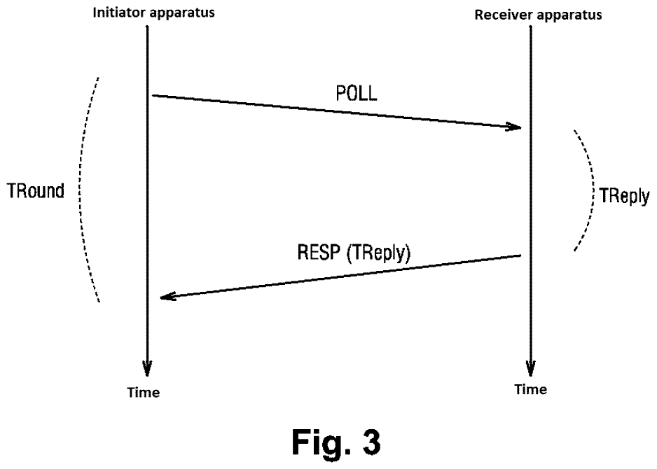

With reference to FIG. 3, in this method, an initiator apparatus sends a first message “POLL”, and a receiver apparatus responds, a specific amount of time after the message is emitted, by emitting a second message “RESP”. Thus, at the time TRound between the first message being emitted and the second message being received, the initiator apparatus subtracts the (known) response time TReply of the receiver apparatus.

The initiator apparatus thus obtains the propagation time of two waves. The initiator apparatus thus calculates:

$$ToF = \frac{( TRound - TReply )}{2}$$

The distance between the initiator apparatus and the receiver apparatus is obtained by the formula:

$$Distance = ToF \times c ( where c is the speed of the radio wave in the air ) .$$

TWR also allows the angle of arrival to be measured in receive mode by measuring the time difference of arrival and/or the phase of the signal on a pair of antennas, as will be described.

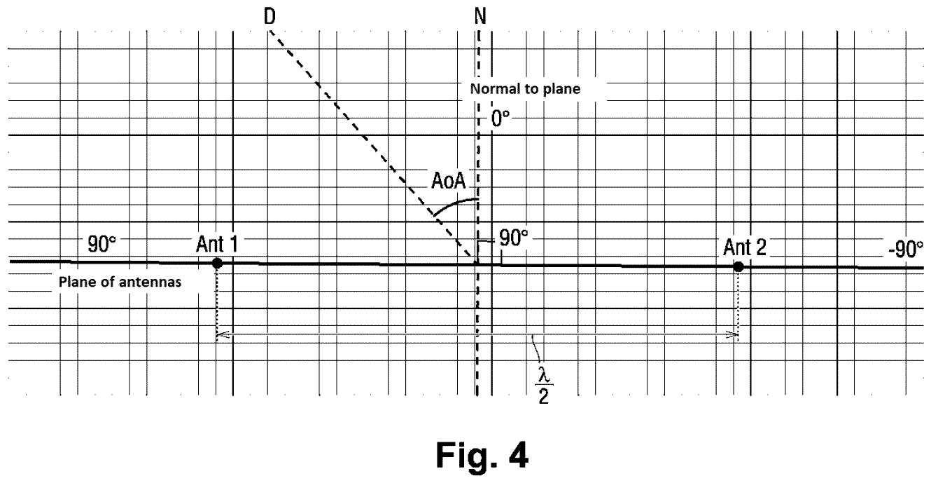

With reference to FIG. 4, the conventional PDoA technique operates as follows with two UWB communication modules each comprising two antennas.

Each UWB communication module is capable of measuring the angle of arrival (AoA), which is the angle between:
the straight line D connecting said UWB communication module and another UWB communication module of another apparatus;
the straight line N normal to said UWB communication module, i.e. an imaginary straight line orthogonal to the plane in which the two UWB antennas Ant1, Ant2 of said UWB communication module extend.

This angle AoA is calculated by measuring the phase shift of the carrier of the signal received between the two antennas Ant1, Ant2, or PDoA (Phase Difference of Arrival). This phase shift corresponds to a small difference in distance between the distance measurement obtained by means of one antenna Ant1 and the distance measurement obtained by means of the other antenna Ant2.

The PDoA is linked to the angle of arrival (AoA) by this equation:

$$AoA = arcsin ( \frac{PDoA \times λ}{2 π d} )$$

where:
λ is the wavelength of the carrier of the UWB signal;
d is the distance between the antennas Ant1, Ant2.

Here, the system is improved as follows.

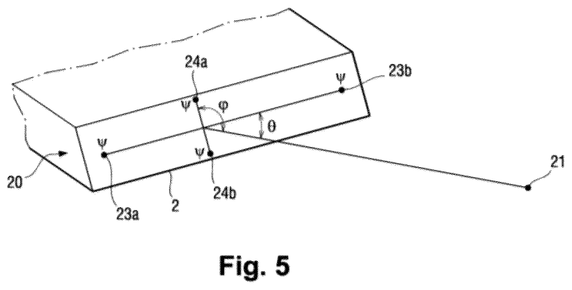

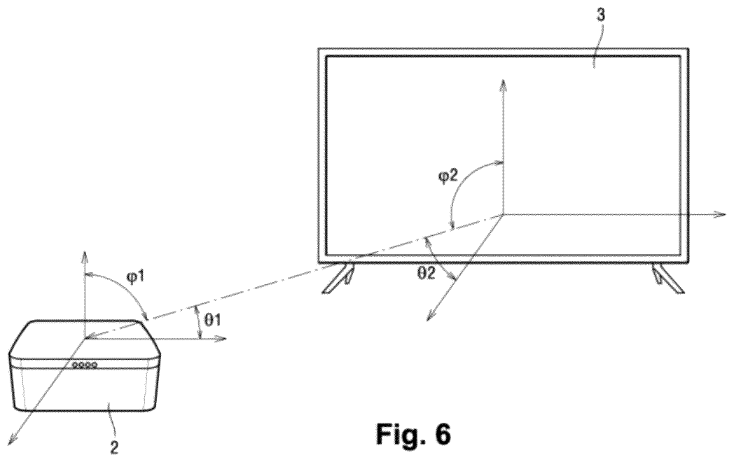

With reference to FIGS. 5 and 6, the primary UWB module 20 of the set-top box 2 here comprises two first pairs of antennas 23a, 23b and 24a, 24b positioned orthogonally to each other, an antenna switch 25 and a processing module 26, which may be integrated in the processing unit 11.

The secondary UWB module 21 of the television 3 comprises at least one second pair of antennas (here two second pairs of antennas 27a, 27b and 28a, 28b positioned orthogonally to each other), an antenna switch 29 and a processing component 30.

The processing module 26 of the primary UWB module 20 therefore controls the antenna switch 25 to measure the angle φ1 and then controls the antenna switch 25 to measure the angle θ1. The primary UWB module 20 generates two consecutive measurements to produce the measurement of the two angles φ1 and θ1.

The primary UWB module 20 also implements the time-of-flight method to measure the distance between the primary UWB module 20 and the secondary UWB module 21, and therefore between the set-top box 2 and the television 3.

The set-top box 2 therefore obtains a measurement in polar coordinates in space with the flight distance on the one hand and the two angles on the other hand.

The set-top box 2 can thus measure the exact position of the secondary UWB module 21 in space with respect to the set-top box 2.

Likewise, the secondary UWB module 21 measures the angles 2 and 02 and can measure the exact position of the set-top box 2 in space relative to the television 3.

The secondary UWB module 21 transmits its measurements to the primary UWB module 20 (by UWB communication), and the processing unit 11 of the set-top box 2 can then determine:
the different orientation angles of the set-top box 2;
the different orientation angles of the television 3;
the distance between the two devices.

The frequency of the carrier of the UWB signal used is, for example, equal to 6.5 GHz. The distance separating the antennas Ant1, Ant2 of a pair of antennas of a UWB module, which is set at λ/2 (see FIG. 4), is therefore equal to approximately 26 mm, which allows the UWB modules 20, 21 to be easily integrated in the set-top box 2 and in the television 3, owing to their small size.

It is noted that it is possible to provide just one pair of antennas in the secondary UWB module 21 of the television 3. The orientation according to one of the angles of the television 3 and of the set-top box 2 is then no longer accessible, but then the television 3 can be considered to be correctly placed in its nominal vertical position and the set-top box 2 in its nominal horizontal position (or vertical position if the set-top box is designed in that way).

In a second embodiment, the first primary locator module is arranged to implement a radar technique, preferably Doppler.

As is known, a radar device allows angles and distances to be measured. Depending on the nature of the radar source, several embodiments can be envisaged.

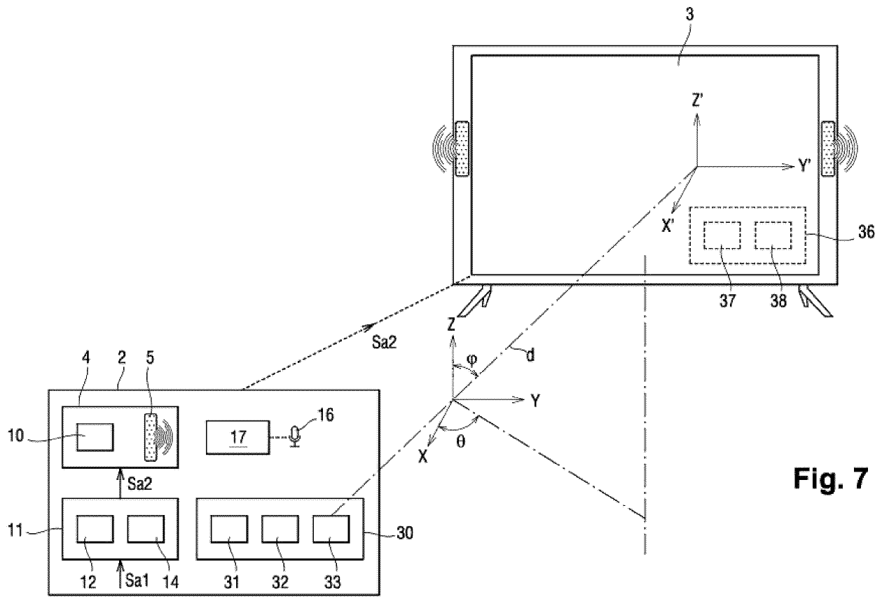

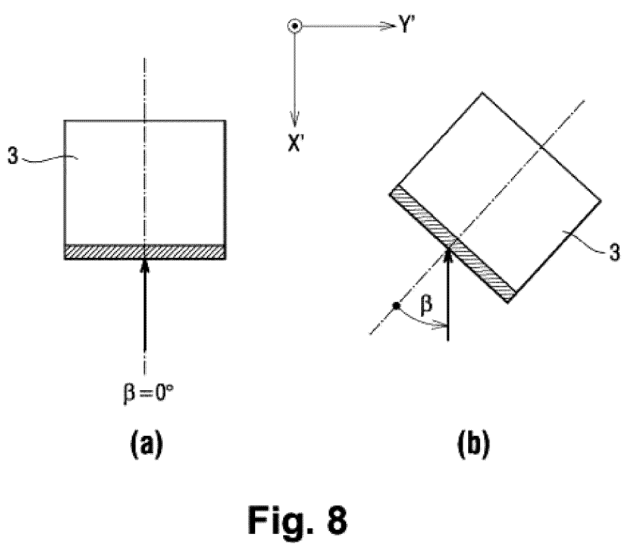

With reference to FIGS. 7 and 8, the first primary locator module 34 of the set-top box 2 comprises a primary radar module 35 comprising a radar source 31, a processing module 32 (possibly integrated in the processing unit 11) and a receiving module 33.

The television 3 is provided with a secondary (radiofrequency) locator module, here a secondary radar module comprising at least one radiofrequency tag 36, which may be passive or active.

Here, the radar source 31 is an FMCW source (Frequency-Modulated Continuous Wave). The source 31 emits a continuous wave. The source 31 is configured to emit a radar signal with a scanning frequency, preferably in the millimetre wave range, for example in the 57-64 GHz frequency band.

In particular, this frequency band has the following advantage. In the event that the audio system 1 comprises a particular number of audio playback apparatuses in addition to the television 3 (for example a plurality of loudspeakers), and therefore a particular number of tags, this frequency band is wide enough to induce a reaction from a large group of RF tags one at a time so as to distinguish between them without any risk of confusion.

The tag 36 of the television 3 is configured to emit a signal at a natural resonance frequency in response to the radar signal.

The receiving module 33 of the set-top box 2 is configured to receive signals emitted by the tag 36 in response to the radar signal.

The processing module 32 of the set-top box 2 is configured to analyse the signals received by the receiving module 33 and to deduce therefrom position parameters of the television 3 with respect to the set-top box 2, these parameters comprising a distance and at least one angle.

Advantageously, the radar source 31, the receiving module 32 and the processing module 33 are implemented in the same component, for example in one of the following 60 GHz radar components: Texas Instrument IWRL6432; Infineon BGT60TR13C (registered trademarks).

The RF tag 36 can be either passive or active (either responding to a specific frequency or relying on a different time response in order to be differentiated and used for locating purposes).

For the RF tag 36 to be easily affixed with a minimum amount of space taken up on the television 3, it is preferably flexible. The tag 36 is made, for example, of a polyamide film (e.g. Kapton, registered trademark) and copper or out of polycarbonate with a layer of printed silver. The tag 36 may comprise patterns resonating at one or more specific frequencies, each resonant frequency being determined in particular by the geometry and size of the patterns.

Thus, this type of circuit makes it possible to define a radar signature characterised by one or more specific resonant frequencies associated respectively with each audio playback apparatus, which advantageously makes it possible to uniquely identify each audio playback apparatus during the sampling by the radar source 31.

For each value of the frequency and of the scanning angle of the radar source 31, the receiving module 33 measures the frequency response, i.e. the amplitude (or power) as a function of the frequency of the signals emitted by the tag 36. On the basis of these amplitudes (or powers), the processing module 32 determines the position coordinates, i.e. the distance d and the azimuth angle θ and optionally the angle of elevation φ of the television 3 with respect to the radar source 31, according to known radar processing techniques.

Advantageously, the processing module 32 also determines the orientation β of the television 3 with respect to its reference position.

In most cases, the television 3 is considered to be positioned at the same height as the set-top box 2 and therefore as the radar source 31 (φ fixed at 90°), such that measuring the azimuth angle θ is sufficient. It is also possible to determine all the parameters d, φ, θ, β.

To do so, during a prior calibration step (for example a factory characterisation), the amplitude (or power) responses of different RF tags are pre-recorded as a function of reference distances dr and orientations βr of each RF tag with respect to the radar source.

It has been found that the amplitude (or power) of the RF tags is sufficiently characteristic for reliably distinguishing between their respective positions d, 0 and orientation β (i.e. the value of the angle of the television 3 relative to the radar source used as the reference).

The RF tag 36 of the television 3 can therefore be a passive tag.

The passive tag may include a resonant surface including an array of dielectric resonators 37 (DR).

The resonators can be formed by spheres of ZrO₂, zirconium dioxide. The frequency response of each sphere has an absorption maximum at 79 GHz and a resonance peak at 86 GHz for a sphere having a diameter equal to 0.6 mm.

These spheres may be arranged in an array, for example in a matrix of size 9×5.

Advantageously, in order to have a tag frequency response that is less dependent on the inclination, i.e. on the angle of incidence of the radar signal on the tag, a reflector can be used.

Use of a tetrahedral reflector has been suggested.

The angular response can then be used to deduce the angular position of the tag in relation to the radar source, taking into account the power re-emitted depending on the angle of incidence of the radar signal.

However, tetrahedral reflectors are bulky and not particularly suitable for being affixed to the surface of an audio playback device such as a television.

Instead of the tetrahedral reflector, a planar Van Atta-type reflector 38 is therefore used.

The RF tag of the television thus comprises a Van Atta reflector and an array of dielectric resonators, for example a matrix of ZrO₂ spheres.

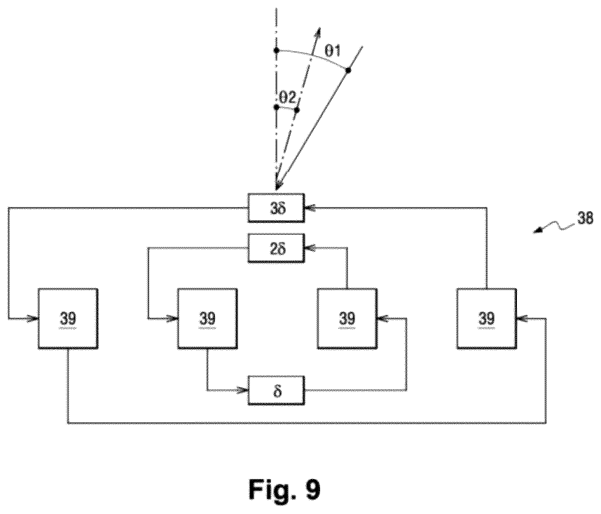

With reference to FIG. 9, the Van Atta reflector 38 is a patch array 39. This reflector emits a signal radiated in response to the incident radar signal.

The incident signal encloses an angle θ1 with the imaginary straight line orthogonal to the plane in which the two antennas extend. The radiated signal has an angle θ2. The resonator creates an angular offset:

$$θ3 = θ 2 - θ 1.$$

δ is a phase gradient.

For example, this reflector is a single-sided circuit, for example a flexible film (made of Kapton, for example) that can be produced by ink-jet printing.

The flexibility of the tag is particularly advantageous because it allows the tag to be affixed to a curved surface, for example in the case of a television 3 having a curved outer surface. It is possible to produce a very small tag (between 1 and 5 cm in length).

To estimate the orientation of the television 3 with respect to the radar source 31, the processing unit 11 of the set-top box 2 acquires and uses the angular response of the Van Atta reflector 38.

The response of the Van Atta reflector depends on the angle of incidence of the radar signal. This response is maximum for a zero angle of incidence (θ1=0°, i.e. when the incident radar signal is perpendicular to the surface of the RF tag) and decreases on either side, forming a main lobe followed by two secondary lobes (one on each side of the main lobe) as the angle of incidence increases.

The power reflected by the reflector can be measured as a function of the angle of incidence and compared with the normal incidence power, i.e. with the reference power that would be obtained for a zero angle (θ1=0°), according to a predefined measurement template (measured at the factory or determined by calculation).

For example, in the case of the passive tag, this measurement will be taken outside the resonances of the dielectric array.

Depending on the power reflected by the tag outside the resonance, by measuring the reflected power for a given angle of incidence the processing unit 11 of the set-top box 2 can advantageously deduce therefrom an estimate of the orientation of the television 3 with respect to the set-top box 2, while taking into account the distance from the target also obtained.

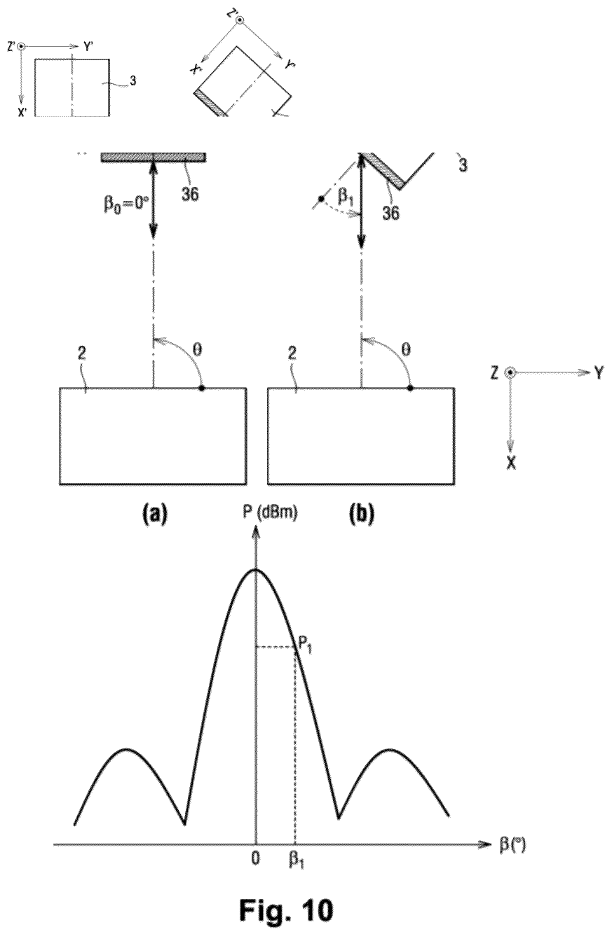

With reference to FIG. 10, it will now be explained how the orientation angle β formed by the normal to the surface of the tag 36 with respect to the normal to the reference surface of the set-top box 2 is measured.

For a given scanning direction θ of the radar source 31, the power P1 reflected by the tag 36 in the scanning direction is measured, and the angle corresponding to the angle β1 is determined according to a predetermined template. This template is obtained in a reference position, corresponding, for example, to the case where the television 3 is positioned directly in front of the set-top box 2 (i.e. where θ=0° and β=) 0°.

RF tags can also be active tags.

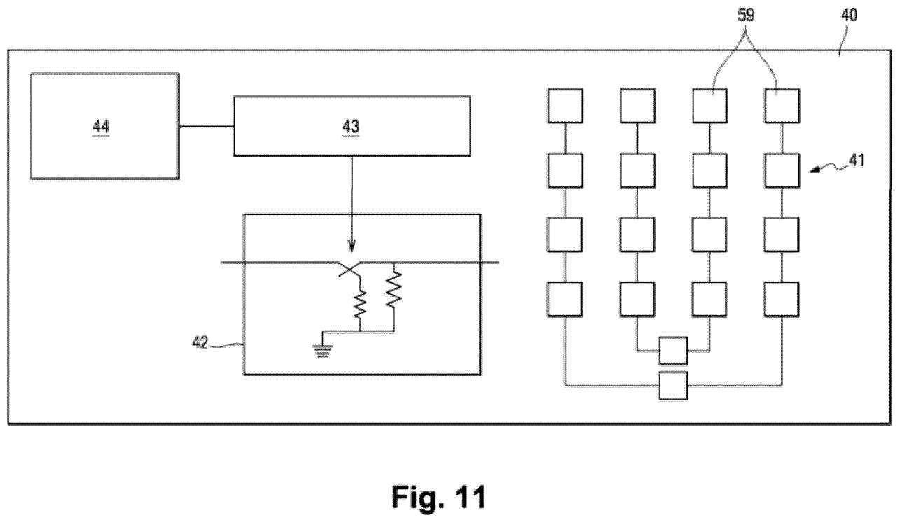

With reference to FIG. 11, each RF tag 40 comprises a reflector 41, one or more microwave switches 42 and a relatively basic processor 43 with low power consumption. By way of example, the processor may be powered by a button cell 44.

The reflector 41 is active for a determined period of time. It is the processor 43 that activates and deactivates the reflector 41, according a determined frequency, by controlling the one or more microwave switches 42.

The reflector 41 is again a Van Atta reflector, which comprises a patch array 59.

The processor 43 may or may not activate the Van Atta array.

When the reflector 41 is activated, it is “visible” to the radar source. When it is deactivated, it disappears for the radar source.

The active tag 40 therefore forms a “flashing” radar target at the frequency determined by the processor.

While the reflector is being activated, the set-top box measures the receive level to estimate the angle of inclination of the tag, as described above.

Another tag, positioned in an orthogonal direction to the first and activated by the same processor but over disjoint time intervals, would make it possible, as described above, to measure the angle in an orthogonal axis, thereby accessing a 3D measurement.

It is noted that the RF tags can also be implemented by multi-frequency resonant circuits printed on PCBs, like existing passive UWB RFID tags. Such circuits consist of three resonators (for example two spiral resonators connected by a line resonator (transmission line), each resonator being able to be configured in active or passive mode corresponding to two binary states, i.e. a total of 2³=8 states, i.e. 8 possible codes). Thus, these circuits can be configured to have different frequency responses, thereby making it possible to encode different binary sequences.

The acquisition of the at least one audio parameter representative of the acoustic response of the television 3 will now be addressed.

The at least one audio parameter is selected from:
an acoustic delay due to a transmission chain between the set-top box 2 and the television 3 and/or due to processing performed by the television, and
a transfer function of the television 3.

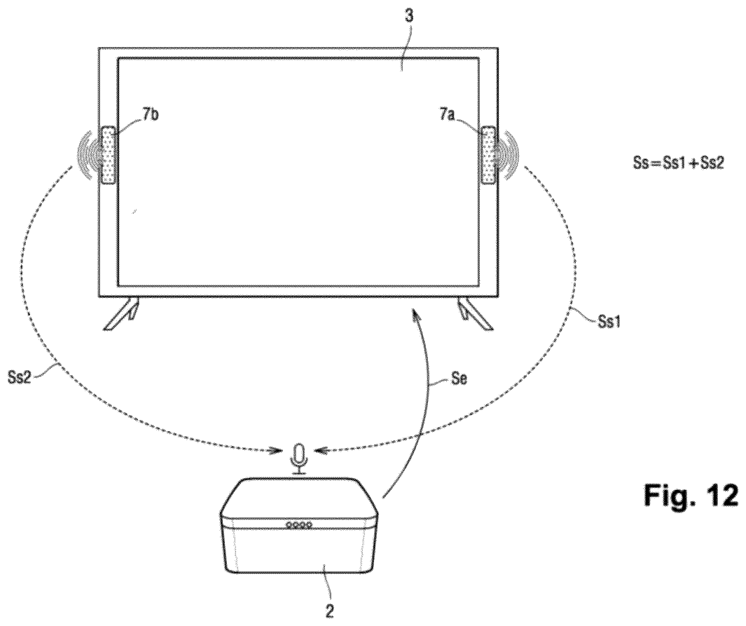

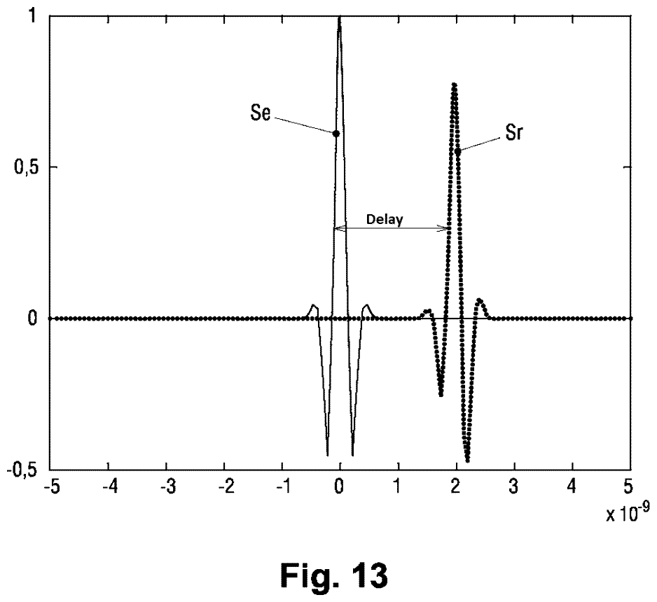

With reference to FIGS. 12 to 14, to determine the acoustic delay, the set-top sends box 2 an emitted synchronisation signal Se (audio signal) to the television 3 via the HDMI link.

When the television 3 receives the emitted synchronisation signal Se, the television 3 applies the emitted synchronisation signal to its loudspeakers 7, which generate a sound synchronisation signal Ss. The loudspeaker 7a generates the signal Ss1, and the loudspeaker 7b generates the signal Ss2:

$$S s = Ss 1 + Ss 2$$

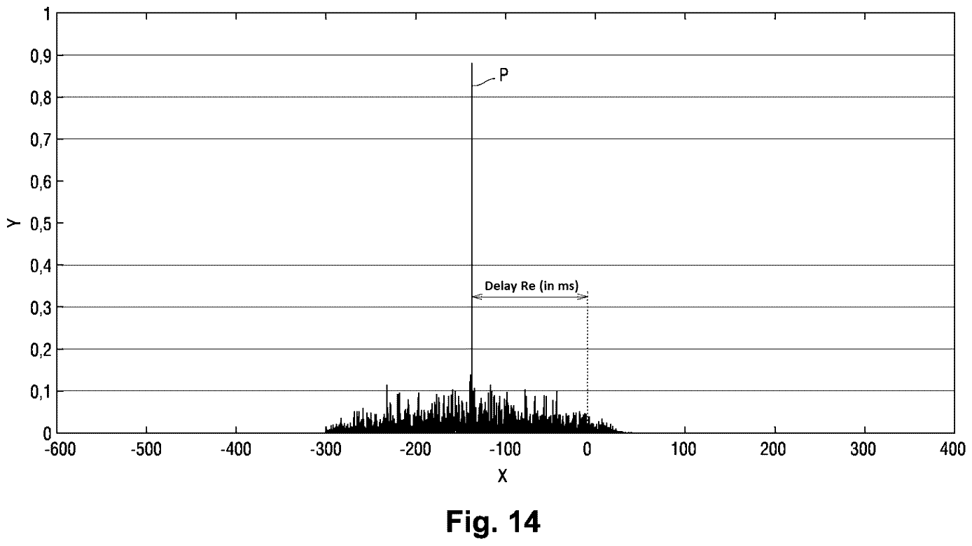

The microphones 16 of the set-top box 2 capture the sound synchronisation signal Ss and produce a received synchronisation signal Sr. Then, the set-top box 2 estimates the acoustic delay in real time. To do so, the processing unit 11 calculates the intercorrelation between the emitted synchronisation signal Se sent to the television and the received synchronisation signal Sr. By way of example, the intercorrelation signal is similar to the signal of FIG. 14. The time at which the peak P occurs corresponds to the delay Re.

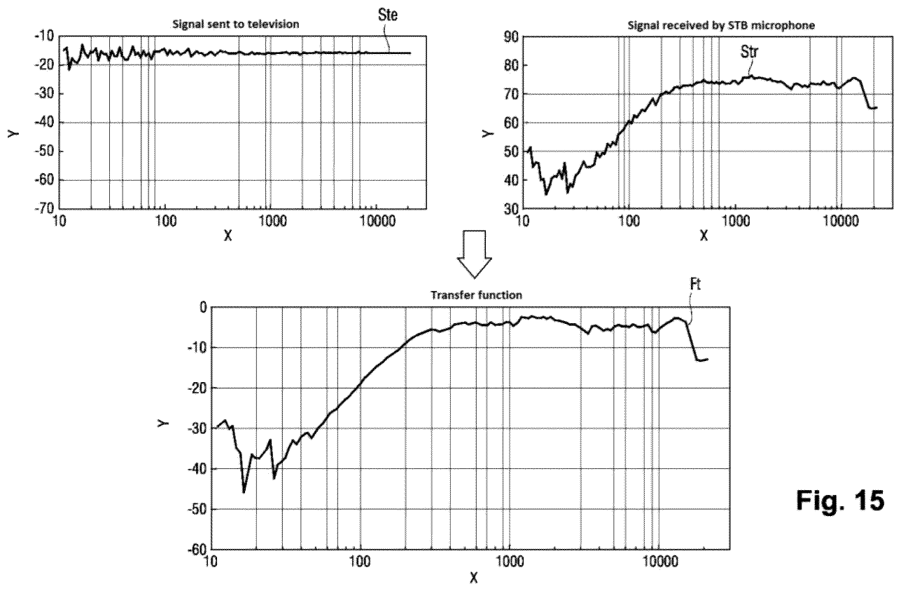

With reference to FIG. 15, to obtain the transfer function Ft, the set-top box 2 transmits an emitted test signal Ste to the television and then uses the microphones to capture the sound test signal produced by the loudspeakers of the television from the test audio signal. The microphones produce a received test signal Str. The processing unit deduces the transfer function from the emitted test signal Ste and the received test signal Str.

The transfer function Ft in dB is such that:

$$Ft = S t r - Ste$$

where Str is the sound response, i.e. the received test signal produced by the microphones 16 of the set-top box 2, and Ste is the excitation, i.e. the emitted test signal sent to the television 3.

In the example of FIG. 15, the emitted test signal Ste is a pink-noise signal over a frequency band between 10 and 18,000 Hz. Other examples of test signals may be used, such as a white-noise signal.

Advantageously, the at least one audio parameter comprises an indicator of a sound level change of the television 3, resulting from a volume control issued by a user to the television 3, the processing unit 11 of the set-top box 2 being arranged to detect the volume change and adapt the first audio signal(s) Sa1 transmitted to the television 3 in order to compensate for said sound level change.

Preferably, the sound level change is detected by the processing unit 11 by comparing the transfer function obtained at two different times. If the sound volume of the television 3 increases or decreases, the level of the transfer function (in dB) is increased or reduced overall by a given amount over the entire range of response frequencies of the television 3. For example, this quantity is obtained by subtracting the transfer function obtained at a first time and the transfer function obtained at a second time. The indicator of the volume change of the television 3 is therefore, for example, equal to said quantity.

In a first embodiment, the audio system 1 is configured such that the overall sound volume is intended to be managed by the user solely by volume controls issued to the set-top box 2 (i.e. via the remote control of the set-top box 2). The volume controls sent by the user via the remote control of the television 3 therefore must not have any effect on the overall sound volume experienced.

In this case, when the user sends a volume control to the television 3 (via the remote control of the television 3), this control modifies the configuration of the television and therefore the transfer function of the television. The processing unit 11 of the set-top box 2 then modifies the first audio signal Sa1 of the television 3 so as to compensate for this volume change. For example, if the user lowers the volume of the television 3 by 5 dB, the transfer function will be lowered by 5 dB. The level of the second audio signal Sa2 sent to the television 3 is increased, by a control system based on the comparison of the real-time level with a reference level defined when the set-top box 2 is switched on, in order to compensate for the change in configuration of the television 3 and to ensure the sound balance of the entire audio system 1.

In a second embodiment, the audio system 1 is configured such that the overall sound volume can also be managed by the user by volume controls issued to the television 3 (i.e. via the remote control of the television).

In this case, when the user sends a volume control to the television 3, for example to lower the volume, this control modifies the configuration of the television 3 and therefore the transfer function of the television 3.

This volume control is taken into account by the television 3, but it is the set-top box 2 that continues to manage the overall sound volume.

The set-top box 2 therefore lowers the overall sound volume in the system by the equivalent level but increases the level sent to the television 3 so that it does not experience twice the drop in sound level.

The invention therefore allows the television 3 to be acoustically characterised in the user's environment (acoustic performance including frequency response and efficiency by taking into account reverberations and reflections of the sound depending on the position of the television 3 with respect to the walls of the room and objects) and ensures immersive sound playback including the loudspeakers 7 of the television 3. The processing unit 11 configures the audio system 1 in real time, using the location data and the audio parameters.

The processing unit 11 of the set-top box 2 is also arranged to adapt the first audio signal Sa1 transmitted to the television 3 depending on the orientation of the television 3 and its transfer function Ft.

Owing to the distance and orientation information collected by the radio-wave locating, the set-top box 2 adds an acoustic compensation to the previous instances of processing depending on the orientation of the television speakers, taking into account the standard directivity of a television loudspeaker. This is known in general for loudspeaker dimensions of a few centimetres, which are compatible with use in a television (3 to 8 cm usually).

A transfer function with high attenuation in the treble may be due to a loudspeaker that is not very efficient in this frequency band, to a television 3 oriented at a large angle with respect to the set-top box (70 to 90°), or to a large distance between the television 3 and the set-top box 2 in a listening room heavily loaded with treble-absorbing materials. The information on the distance and angle(s) previously determined by means of the locating means 15 makes it possible to overcome the two aforementioned uncertainties and therefore to propose an amplification of the treble in the signal sent to the television 3 to compensate for the weakness of the loudspeaker. The processing unit 11 therefore adjusts the levels of the first audio signal Sa1 sent to the television 3 depending on the acoustic frequency, the orientation and/or the position of the television 3.

As already stated, the processing unit 11 of the set-top box 2 acquires the position and (optionally) the orientation of the television 3, acquires the audio parameter(s) and adapts at least one of the first audio signals Sa1 of the audio stream depending on this information to obtain the second audio signals Sa2. The processing unit 11 then transmits the second audio signals Sa2 to the different audio devices to implement this “optimised” multichannel playback.

As set out above, the audio system 1 can include other audio playback apparatuses, for example speakers. These speakers are therefore provided with RF tags as described above.

The processing unit 11 therefore knows the position of the speakers and of the television 3 and can adapt some of the first audio signals Sa1 to produce second audio signals Sa2 intended for said apparatuses, which are adapted so as to have specific functionalities depending on their position, for example their elevation (up-firing), their acoustic performance, particular functions (subwoofer), etc.

This configuration is used to feed the “mapping” of the immersive sound provider in real time. Thus, a configuration specific to the presence of the television 3 can be provided in the event that the television 3 contributes to the sound playback with its integrated loudspeakers 7, thus allowing the sound rendering in the listening space of the user to be enhanced.

The application of the invention is not limited to surround channels but more generally to an audio system comprising other audio playback channels, such as lateral subwoofers and HPs.

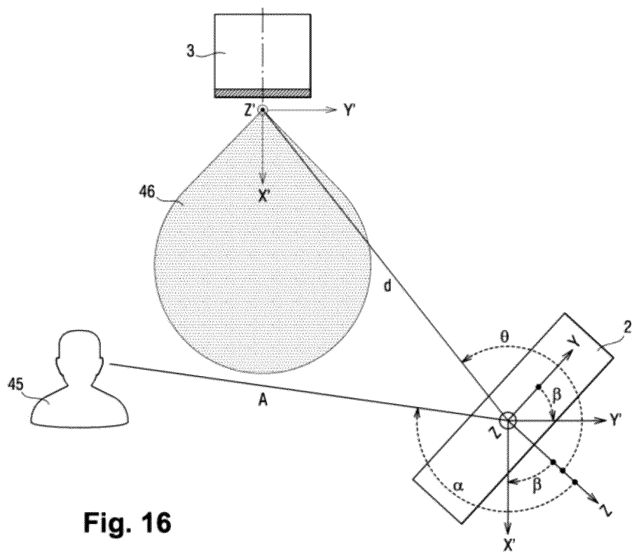

Advantageously, with reference to FIG. 16, the set-top box 2 also determines the position (A, a) of the user 45. The processing unit 11 also adapts the first audio signals Sa1 depending on the position of the user.

To optimally configure an audio system comprising a plurality of audio devices, and therefore to obtain immersive rendering, it is essential to determine the angular position (distance, angle) and also the orientation of each of the speakers relative to the user 45 since the acoustic diagram 46, and therefore the relative power of the speaker at a given point, depends on the power of the speaker and the acoustic directivity diagram, which is linked to the orientation of the speaker.

As soon as the position of the user and the positions and orientations of all the audio playback devices are obtained, the processing unit 11 uses this information to configure these devices so as to optimise the sound rendering depending on the position of the user.

Since the distances (d, A) and angles (θ, β) are determined at regular (configurable) time intervals, the configuration can be adjusted in real time depending on the position of the user. It is noted that the invention can also be implemented in the event that the set-top box does not comprise means for locating the television or means for capturing the audio parameters of the television.

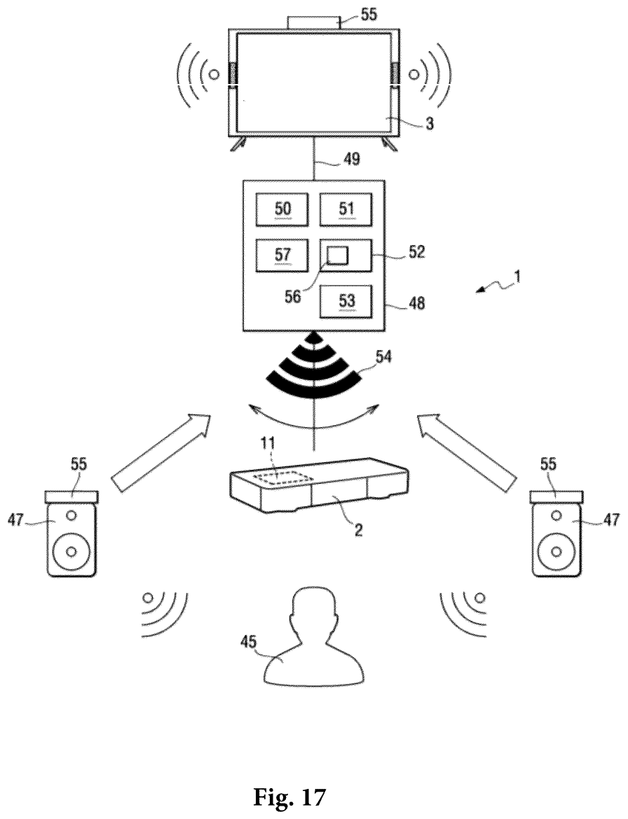

With reference to FIG. 17, the audio system 1 comprises loudspeakers of the television 3 and the speakers 47.

This time, the set-top box 2 is a “conventional” set-top box which does not comprise a loudspeaker or locating means.

An ancillary apparatus 48 is integrated in the audio system 1. The ancillary apparatus 48 is a dongle, for example.

Here, the ancillary apparatus 48 is connected to the television 3, for example by an HDMI link 49.

The ancillary apparatus 48 comprises a processing unit 50 (comprising, like the processing unit 11, at least one processing component and at least one memory), a second primary locator module 51, an audio capture module 52 and a first communication module 53.

The ancillary apparatus 48 is connected to the set-top box 2 by the first communication module 53. The first communication module 53 implements a wired connection or a wireless connection 54. By way of example, the wired link is an HDMI link. For example, the ancillary apparatus 48 is configured in “pass through” mode, i.e. letting through the entirety of the audio/video signal from the set-top box 2.

The first communication module 53 may also comprise a wired communication interface of another type (e.g. Ethernet) for communicating with the set-top box 2.

The second primary locator module 51 of the ancillary apparatus 48 evaluates the position (and advantageously the orientation) of the television 3. The second primary locator module 51 carries out a locating method using radiofrequency waves. Preferably, the locating method is the same as that described above when implemented by the set-top box 2.

The second primary locator module 51 comprises, for example, the primary UWB module, or the radar source, the receiving module and the processing module described above.

The audio capture module 52 comprises at least one microphone 56 and is arranged to produce the at least one audio parameter representative of the acoustic response of the television 3.

Here, for space-saving reasons, the ancillary apparatus 48 does not have any loudspeakers.

The television 3 and the speakers 47 each comprise a radiofrequency locator module 55, for example a tag.

It is therefore the ancillary apparatus 48 that determines the position and orientation of the television and of the audio speakers 47 by using a locating method that uses radiofrequency waves. It is also the ancillary apparatus 48 that evaluates the audio parameter(s) representative of the acoustic responses of the television 3 and the speakers 47.

These data are transmitted to the processing unit 11 of the set-top box 2. The processing unit 11 acquires the data, adapts the first audio signals Sa1 depending on this data, produces the second audio signals Sa2 and implements the multichannel audio playback using the second audio signals Sa2.

In one embodiment, it is the set-top box 2 that transmits the second audio signals Sa2 to the audio devices of the audio system 1.

In another embodiment, the ancillary apparatus 48 further comprises a second communication module 57 arranged to transmit the second audio signals to the audio devices of the audio system 1 to implement multichannel audio playback.

The first communication module 53 of the ancillary apparatus 48 then receives the second audio signals Sa2 produced by the set-top box 2 and transmitted by the set-top box 2 to the ancillary apparatus 48. It is then the ancillary apparatus 48 that transmits the second audio signals Sa2 to the audio devices to implement the multichannel audio playback.

By way of example, the second communication module 57 comprises a wireless communication interface, for example according to the IEEE 802.11 protocol (Wi-Fi).

Thus, the ancillary apparatus 48 is configured to send one or more streams of audio data over Wi-Fi to a plurality of wireless audio playback devices.

In the example of FIG. 17, the ancillary apparatus 48 is configured to send two separate audio streams to two wireless speakers 47 (Wi-Fi).

It goes without saying that the ancillary apparatus 48 may be configured according to any other wireless communication protocol compatible with the wireless audio playback devices in question.

Thus, the ancillary apparatus 48 having its wireless communication interface can advantageously be associated with an audiovisual decoder that does not have wireless communication capabilities. In this case, the ancillary apparatus 48 allows wireless speakers to be used, to make installation even simpler.

Using the apparatus 48 ancillary is particularly advantageous in the event that the set-top box 2 at the subscriber's location does not also have integrated loudspeakers. In this case, the subscriber can enjoy an immersive system in particular with 360° sound playback by using known wireless surround speakers and the loudspeakers of the unknown television 3.

According to an alternative embodiment, the ancillary apparatus 48 is configured to retrieve from the television 3 information relating to the television 33 (for example the make of the television, the model, the number and distribution of the HPs on the television), for example via the HDMI link by accessing the EDID (Extended Display Identification Data) of the television, so that it can accurately position the loudspeakers of the television in the sound space once the RF tag associated with the television has been located.

It goes without saying that the invention is not limited to the described embodiments but covers any variant falling under the scope of the invention as defined by the claims.

As set out above, the audio playback apparatus whose position (and possibly orientation) are used to adapt the audio signals of the multichannel playback is not necessarily a television.

Likewise, the audio broadcasting apparatus is not necessarily a set-top box; it may be a different apparatus, for example a Hi-Fi amplifier connected to speakers.

To determine the position (and possibly the orientation) of the one or more audio playback apparatuses, it would be possible to use antennas of the audio broadcasting apparatus (and other RF components) that are already used for other functions. For example, in the case of the set-top box, the antennas used for communication in a Wi-Fi network could be used. Likewise, the microphones used may be microphones initially intended for other functions (for example the voice assistant function). This makes the invention very inexpensive to implement since it does not require any dedicated hardware means, with the exception of the RF tag positioned on the audio playback apparatus.

The locator modules may implement different technologies from those described herein. It is possible, for example, to use LiDAR signals (Light Detection And Ranging) or Wi-Fi (or signals from any other radio communication method) to carry out the time-of-flight measurement method. Use of the FMCW mode has been described for the locating method using Doppler radar. Another possible embodiment uses pulse-Doppler radar, which is based on wave trains and is compatible with the UWB standard (which also has a pulse-Doppler radar mode since it is based on messages and is therefore of a pulsed nature).

1. An audio broadcasting apparatus arranged to implement multichannel audio playback on the basis of first audio signals in an audio system comprising a plurality of audio devices, at least one of the audio devices being integrated in an audio playback apparatus separate from the audio broadcasting apparatus, the audio broadcasting apparatus comprising a processing unit arranged to:
acquire a position of the audio playback apparatus, said position being obtained by a locating method using radiofrequency waves;
acquire at least one audio parameter representative of an acoustic response of the audio playback apparatus;
adapt at least one of the first audio signals depending on the position of the audio playback apparatus and the at least one audio parameter, to obtain second audio signals; and
implement the multichannel audio playback using the second audio signals.

2. The audio broadcasting apparatus according to claim 1, wherein
the processing unit is also arranged to acquire an orientation of the audio playback apparatus and to also adapt at least one of the first audio signals depending on the orientation of the audio playback apparatus.

3. The audio broadcasting apparatus according to claim 1, comprising a first primary locator module arranged to carry out a time-of-flight measurement method to measure a distance between the audio broadcasting apparatus and the audio playback apparatus, and an angle measurement method to measure at least one angle between the audio broadcasting apparatus and the audio playback apparatus.

4. The audio broadcasting apparatus according to claim 3, wherein the first primary locator module comprises a primary UWB module arranged to communicate with a secondary UWB module of the audio playback apparatus.

5. The audio broadcasting apparatus according to claim 4, the primary UWB module comprising two first pairs of antennas positioned orthogonally to each other, the two first pairs of antennas being arranged to interact with at least one second pair of antennas integrated in the secondary UWB module.

6. The audio broadcasting apparatus according to claim 3, wherein the first primary locator module is arranged to implement a radar technique, preferably Doppler, and comprises a radar source arranged to interact with at least one radiofrequency tag positioned on the audio playback apparatus.

7. The audio broadcasting apparatus according to claim 1, wherein said at least one audio parameter is selected from:
an acoustic delay due to a transmission chain between the audio broadcasting apparatus and the audio playback apparatus and/or due to processing performed by the audio playback apparatus; and
a transfer function of the audio playback apparatus.

8. The audio broadcasting apparatus according to claim 1, wherein the at least one audio parameter comprises an indicator of a sound level change resulting from a volume control issued by a user to the audio playback apparatus, the processing unit being arranged to adapt, depending on said indicator, at least one first audio signal transmitted to the audio playback apparatus so as to compensate for said sound level change.

9. The audio broadcasting apparatus according to claim 1, the audio broadcasting apparatus being a set-top box that includes an audio device comprising at least one loudspeaker.

10. The audio broadcasting apparatus according to claim 1, the audio broadcasting apparatus being arranged to determine a position of a user, the processing unit being arranged to also adapt at least one first audio signal depending on the position of the user.

11. The audio broadcasting apparatus according to claim 1, the audio broadcasting apparatus being connected to an ancillary apparatus separate from both the audio broadcasting apparatus and the audio playback apparatus and being arranged to receive from said ancillary apparatus the position of the audio playback apparatus and said at least one audio parameter.

12. An audio broadcasting method carried out in the processing unit of an audio broadcasting apparatus according to claim 1, comprising the steps of:
acquiring a position of the audio playback apparatus, said position being obtained by a locating method using radiofrequency waves;
acquiring at least one audio parameter representative of an acoustic response of the audio playback apparatus;
adapting at least one of the first audio signals depending on the position of the audio playback apparatus and the at least one audio parameter, to obtain second audio signals; and
using the second audio signals to implement the multichannel audio playback.

13. A computer program comprising instructions that cause the processing unit of the audio broadcasting apparatus according to any of claim 1 to execute the steps of the audio broadcasting method, comprising the steps of:
acquiring a position of the audio playback apparatus, said position being obtained by a locating method using radiofrequency waves;
acquiring at least one audio parameter representative of an acoustic response of the audio playback apparatus;
adapting at least one of the first audio signals depending on the position of the audio playback apparatus and the at least one audio parameter, to obtain second audio signals; and
using the second audio signals to implement the multichannel audio playback.

14. A non-transitory computer readable storage medium on which the computer program according to claim 13 is stored.

15. An ancillary apparatus arranged to be connected to an audio broadcasting apparatus according to claim 11, the ancillary apparatus comprising:
a second primary locator module arranged to evaluate the position of the audio playback apparatus, the second primary locator module being arranged to carry out the locating method using radiofrequency waves;
an audio capture module comprising at least one microphone and arranged to produce the at least one audio parameter representative of the acoustic response of the audio playback apparatus; and
a first communication module arranged to transmit to the audio broadcasting apparatus the position of the audio playback apparatus and the at least one audio parameter.

16. The ancillary apparatus according to claim 15, the first communication module being arranged to receive the second audio signals transmitted by the audio broadcasting apparatus, the ancillary apparatus further comprising a second communication module arranged to transmit the second audio signals to the audio devices of the audio system to implement the multichannel audio playback.

17. A system comprising the audio broadcasting apparatus according to claim 1 and a secondary locator module, which is arranged to be positioned on the audio playback apparatus and used to carry out the locating method.

18. The system according to claim 17, comprising a first primary locator module arranged to carry out a time-of-flight measurement method to measure a distance between the audio broadcasting apparatus and the audio playback apparatus, and an angle measurement method to measure at least one angle between the audio broadcasting apparatus and the audio playback apparatus, wherein the first primary locator module is arranged to implement a radar technique, preferably Doppler, and comprises a radar source arranged to interact with at least one radiofrequency tag positioned on the audio playback apparatus, the radiofrequency locator module comprising said at least one radiofrequency tag, which is a passive tag comprising an array of dielectric resonators and a Van Atta reflector.

19. The system according to claim 17, comprising a first primary locator module arranged to carry out a time-of-flight measurement method to measure a distance between the audio broadcasting apparatus and the audio playback apparatus, and an angle measurement method to measure at least one angle between the audio broadcasting apparatus and the audio playback apparatus, wherein the first primary locator module is arranged to implement a radar technique, preferably Doppler, and comprises a radar source arranged to interact with at least one radiofrequency tag positioned on the audio playback apparatus, the radiofrequency locator module comprising the at least one radiofrequency tag, which is an active tag comprising a Van Atta reflector, a microwave switch and a processor arranged to activate and deactivate the Van Atta reflector, according to a determined frequency, by controlling the one or more microwave switches.

20. The system according to claim 17, further comprising an ancillary apparatus arranged to be connected to the audio broadcasting apparatus, the ancillary apparatus comprising:
a second primary locator module arranged to evaluate the position of the audio playback apparatus, the second primary locator module being arranged to carry out the locating method using radiofrequency waves;
an audio capture module comprising at least one microphone and arranged to produce the at least one audio parameter representative of the acoustic response of the audio playback apparatus; and
a first communication module arranged to transmit to the audio broadcasting apparatus the position of the audio playback apparatus and the at least one audio parameter (Ft, Re).
